(19) United States
(12) Patent Application Publication
(10) Pub. No.: US 2011/0208464 A1
(43) Pub. Date: Aug. 25, 2011

(54) REPORT GENERATION SYSTEM AND METHOD

(75) Inventors: CHIEN-HUNG LIU, Tu-Cheng (TW); HSIEN-CHUAN LIANG, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 12/824,223

(22) Filed: Jun. 27, 2010

(30) Foreign Application Priority Data
Feb. 24, 2010 (TW) 99105271

(51) Int. Cl. G06F 19/00; G06F 17/00

(52) U.S. Cl. 702/108; 715/212

(57) ABSTRACT

In a report generation system and method, one or more test parameters, a measured characteristic, and value ranges of the measured characteristic are set. Values of the one or more test parameters and the measured characteristic are retrieved from measurement data. The values are arranged to create a report of the measured characteristic versus the one or more test parameters. Each of the values of the measured characteristic is classified into one of the value ranges. The report is marked according to the value ranges of the values of the measured characteristic.

### BACKGROUND

1. Technical Field

Embodiments of the present disclosure relate to data analysis, and particularly to a system and method for report generation.

2. Description of Related Art

Measurement data of an electronic signal may include multiple test parameters (e.g., voltage swing and pre-emphasis) and measured characteristics (e.g., jitter and eye height). The test parameters determine measurement conditions of the electronic signal. The measured characteristics vary as the test parameters vary. Due to various measured characteristics contained in the measurement data, it may be inconvenient to determine value distributions of the test parameters.

### BRIEF DESCRIPTION OF THE DRAWINGS

FIG. 1 is a block diagram of one embodiment of a report generation system.

FIG. 2 is a block diagram of one embodiment of a report generation unit in FIG. 1.

FIG. 3 is a flowchart of one embodiment of a report generation method implementing a report generation system, such as that in FIG. 1.

FIG. 4 illustrates one example of measurement data of a PCIe signal.

FIG. 5 illustrates one example of a report of jitter versus voltage swing and pre-emphasis.

FIG. 6 illustrates one example of the report of FIG. 5 marked in different colors.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

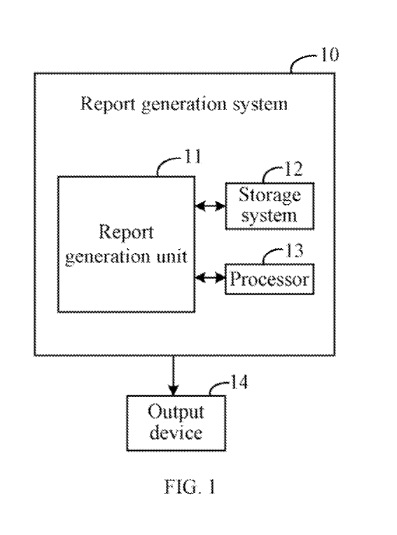

FIG. 1 is a block diagram of one embodiment of a report generation system 10. The report generation system 10 may generate a report depicting a value distribution of a particular measured characteristic of an electronic signal. The report generation system 10 may be a data processing device or a computerized device such as a personal computer, an application server, or a workstation, for example. The report generation system 10 may include a report generation unit 11, a storage system 12, a processor 134. One or more computerized codes of the report generation unit 11 may be stored in the storage system 12 and executed by the processor 13. The storage system 12 may be a flash memory, a hard disk drive, or a cache. The report generation system 10 may be connected to an output device 14 such as a display screen or a printer, which outputs generated reports to users.

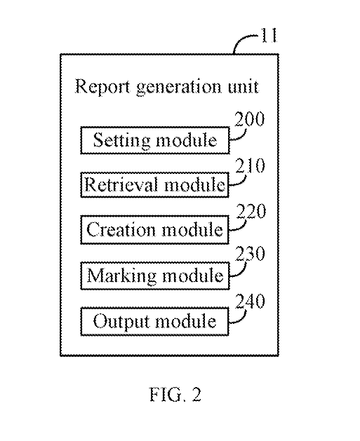

FIG. 2 is a block diagram of one embodiment of the report generation unit 11 in FIG. 1. In one embodiment, the report generation unit 11 may include a setting module 200, a retrieval module 210, a creation module 220, a marking module 230, and an output module 240.

The setting module 200 sets one or more test parameters and a measured characteristic of an electronic signal, and sets value ranges of the measured characteristic according to user requirements. The test parameters determine measurement conditions of the electronic signal. The measured characteristic is a measurement of the electronic signal, which varies with the one or more test parameters. A value range of the measured characteristic is a range of values, such as an interval of (10, 20), for example. If a report showing jitter versus voltage swing and pre-emphasis of an electronic signal is desired, the setting module 200 sets voltage swing and pre-emphasis as the test parameters, and sets jitter as the measured characteristic. The setting module 200 may set various intervals for jitter, such as of (−∞, 0.54), [0.54, 0.84], and (0.84, +∞). (−∞, 0.54) is an interval ranging from negative infinity to 0.54 that does not include 0.54. [0.54, 0.84] is an interval ranging from 0.54 to 0.84 that includes 0.54 and 0.84. (0.84, +∞) is an interval ranging from 0.84 to positive infinity that does not include 0.84.

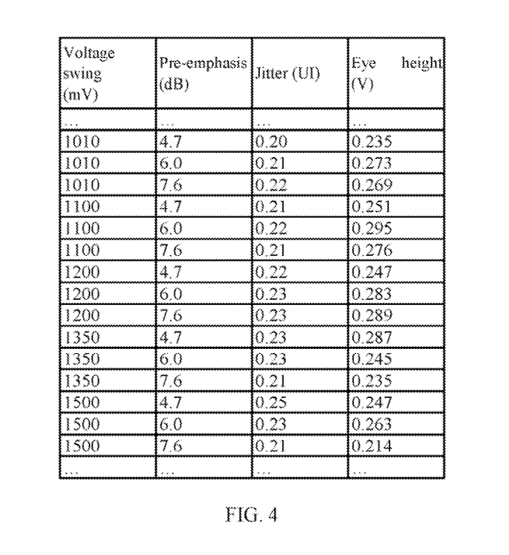

The retrieval module 210 retrieves values of the one or more test parameters and the measured characteristic from the measurement data of the electronic signal. FIG. 4 illustrates one example of the measurement data of a peripheral component interconnect express (PCIe) signal. In some embodiments, the measurement data include voltage swing, pre-emphasis, jitter, and eye height of the PCIe signal. Voltage swing and pre-emphasis are test parameters, jitter and eye height are measured characteristics. The retrieval module 210 may retrieve data in first three columns of the measurement data to obtain values of voltage swing, pre-emphasis, and jitter of the PCIe signal.

The creation module 220 arranges the values of the test parameters and the measured characteristic to create a report of the measured characteristic versus the one or more test parameters. In one embodiment, the report may be created by a spreadsheet application such as MICROSOFT EXCEL. The creation module 220 may arrange the values of the test parameter in a predetermined order, such as an ascending order or a descending order in the report.

The marking module 230 classifies each of the values of the measured characteristic into one of the value ranges. In addition, the marking module 230 marks the report to indicate the value ranges of the values of the measured characteristic. If a value of the measured characteristic is within a value range, the value of the measured characteristic may be classified into the value range. For example, if a value of jitter is 0.65 UI, the value is classified into the value range of [0.54, 0.84]. The marking module 230 may mark the report in different colors to indicate the value ranges of the values of the measured characteristic. Further details are described below.

The output module 240 outputs the marked report to the output device 14. In one embodiment, the output module 240 displays the marked report on a display screen.

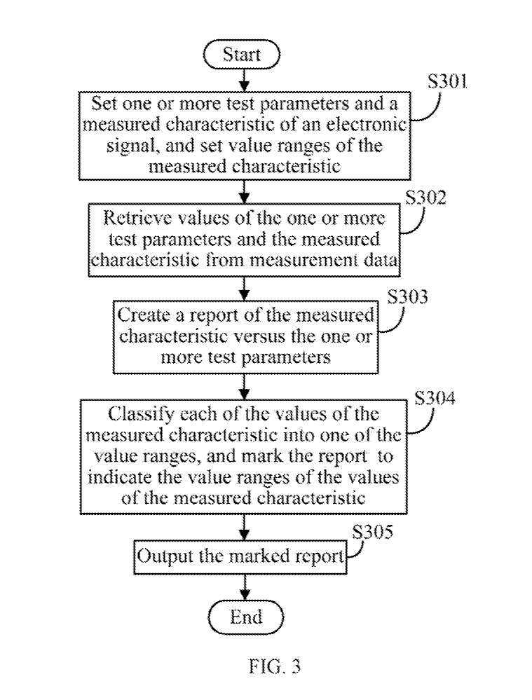

FIG. 3 is a flowchart of one embodiment of a report generation method implementing a report generation system, such as that in FIG. 1. The report generation method may generate a report depicting a value distribution of a particular measured characteristic of an electronic signal. Depending on the embodiment, additional blocks may be added, others removed, and the ordering of the blocks may be changed.

In block S301, the setting module 200 sets one or more test parameters and a measured characteristic of an electronic signal, and sets value ranges of the measured characteristic according to user requirements. If a report of jitter versus voltage swing and pre-emphasis is desired, the setting module 200 sets voltage swing and pre-emphasis as the test parameters, and sets jitter as the measured characteristic. For example, the setting module 200 may set three value ranges for jitter. A first value range may be (−∞, 0.54). A second value range may be [0.54, 0.84]. A third value range may be (0.84, +∞). The first value range may represent a safe zone. The second value range may represent a threshold zone. The third value range may represent a fail zone.

In block S302, the retrieval module 210 retrieves values of the one or more test parameters and the measured characteristic from measurement data of the electronic signal. FIG. 4 illustrates one example of measurement data of a PCIe signal. The measurement data include test parameters of voltage swing and pre-emphasis, and include measured characteristics of jitter and eye height. The retrieval module 210 may retrieve data in first three columns of the measurement data to obtain values of voltage swing, pre-emphasis, and jitter of the PCIe signal.

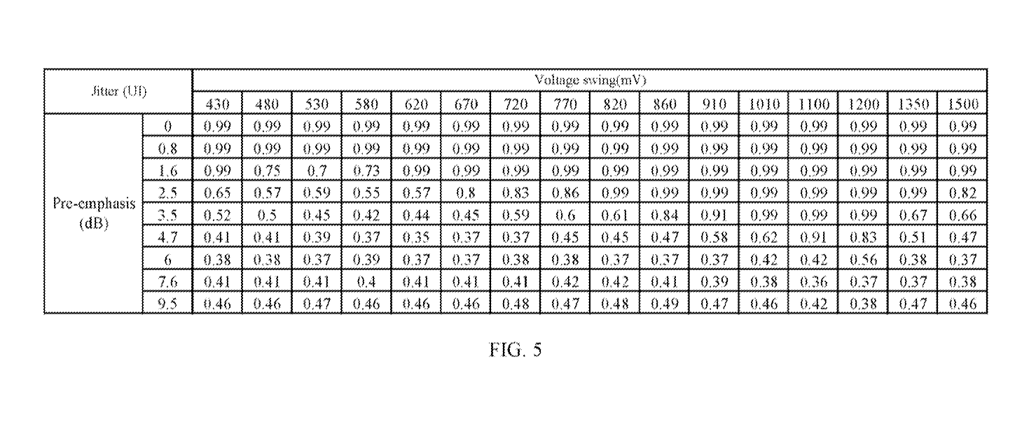

In block S303, the creation module 220 arranges the values of the test parameters and the measured characteristic to create a report of the measured characteristic versus the one or more test parameters. In one embodiment, the report may be created by a spreadsheet application such as MICROSOFT EXCEL. The creation module 220 may arrange the values of the test parameter in a predetermined order, such as an ascending order or a descending order in the report. FIG. 5 illustrates one example of a report of jitter versus voltage swing and pre-emphasis. Values of voltage swing are shown at the top of the report in an ascending order. Values of pre-emphasis are shown at the left of the report in an ascending order. Values of jitter are shown in cells of the report, each cell corresponding to a voltage swing value and a pre-emphasis value. For example, if the voltage swing is 530 mV and the pre-emphasis is 1.6 dB, the jitter is 0.7 UI.

In block S304, the marking module 230 classifies each of the values of the measured characteristic into one of the value ranges, and marks the report to indicate the value ranges of the values of the measured characteristic. As mentioned above, if a value of the measured characteristic is within a value range, the value of the measured characteristic may be classified into the value range.

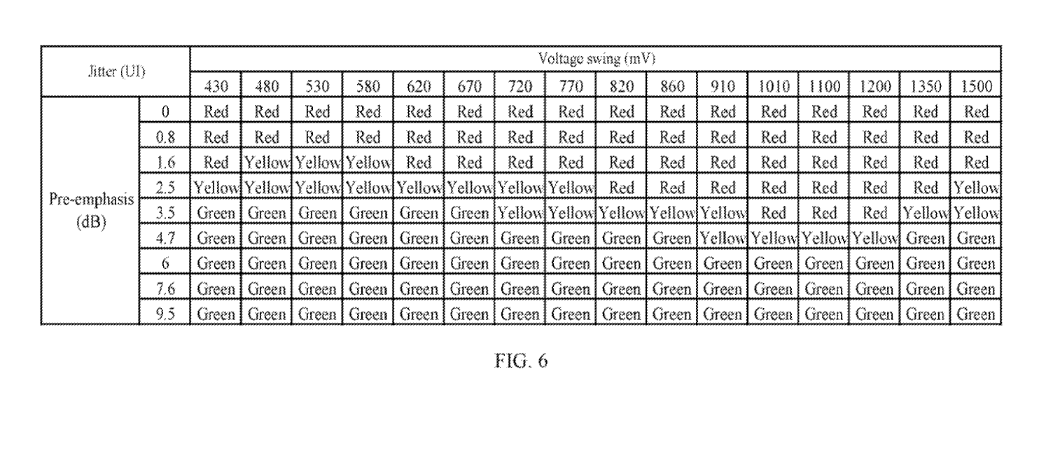

The marking module 230 may mark the report in different colors to indicate the value ranges of the values of the measured characteristic. FIG. 6 illustrates one example of the report of FIG. 5 marked in different colors, where the measured characteristic is jitter. If a value of jitter is classified into the first value range of (−∞, 0.54), a corresponding cell of the report is marked in green. If a value of jitter is classified into the second value range of [0.54, 0.84], a corresponding cell of the report is marked in yellow. If a value of jitter is classified into the third value range of (0.84, +∞), a corresponding cell of the report is marked in red.

In another embodiment, the marking module 230 may mark the report with different lines. For example, if a value of jitter is classified into the first value range of (−∞, 0.54), the marking module 230 marks a corresponding cell of the report with horizontal lines. If a value of jitter is classified into the second value range of [0.54, 0.84], the marking module 230 marks a corresponding cell of the report with bias lines. If a value of jitter is classified into the third value range of (0.84, +∞), the marking module 230 marks a corresponding cell of the report with vertical lines.

In block S305, the output module 240 outputs the marked report to the output device 1, such as a display screen. For example, the output module 240 outputs the marked report of jitter versus voltage swing and pre-emphasis to the output device 14.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A report generation system, the system comprising:
a storage system;
at least one processor;
a report generation unit being stored in the storage system and executable by the at least one processor, the report generation unit comprising:
a setting module operable to set one or more test parameters and a measured characteristic of an electronic signal, and set value ranges of the measured characteristic;
a retrieval module operable to retrieve values of the one or more test parameters and the measured characteristic from measurement data of the electronic signal;
a creation module operable to arrange the values of the one or more test parameters and the measured characteristic to create a report of the measured characteristic versus the one or more test parameters;
a marking module operable to classify each of the values of the measured characteristic into one of the value ranges, and mark the report according to the value ranges of the values of the measured characteristic; and
an output module operable to output the marked report to an output device.

2. The report generation system of claim 1, wherein the report is created by a spreadsheet application.

3. The report generation system of claim 1, wherein the creation module arranges the values of the one or more test parameters in a predetermined order in the report.

4. The report generation system of claim 1, wherein the report is marked in different colors to indicate the value ranges of the values of the measured characteristic.

5. The report generation system of claim 1, wherein the output device is a display screen or a printer.

6. A report generation method, comprising:
setting one or more test parameters and a measured characteristic of an electronic signal, and setting value ranges of the measured characteristic;
retrieving values of the one or more test parameters and the measured characteristic from measured data of the electronic signal;
arranging the values of the one or more test parameters and the measured characteristic to create a report of the measured characteristic versus the one or more test parameters;
classifying each of the values of the measured characteristic into one of the value ranges, and marking the report according to the value ranges of the values of the measured characteristic; and
outputting the marked report to an output device.

7. The method of claim 6, wherein the report is created by a spreadsheet application.

8. The method of claim 6, wherein the values of the one or more test parameters are arranged in a predetermined order in the report.

9. The method of claim 6, wherein the report is marked in different colors to indicate the value ranges of the values of the measured characteristic.

10. The method of claim 6, wherein the output device is a display screen or a printer.

11. A computer-readable medium having stored thereon instructions that, when executed by a computerized device, causes the computerized device to execute a report generation method, the method comprising:
setting one or more test parameters and a measured characteristic of an electronic signal, and setting value ranges of the measured characteristic;
retrieving values of the one or more test parameters and the measured characteristic from measured data of the electronic signal;
arranging the values of the one or more test parameters and the measured characteristic to create a report of the measured characteristic versus the one or more test parameters;
classifying each of the values of the measured characteristic into one of the value ranges, and marking the report according to the value ranges of the values of the measured characteristic; and
outputting the marked report to an output device.

12. The computer-readable medium of claim 11, wherein the report is created by a spreadsheet application.

13. The computer-readable medium of claim 11, wherein the values of the test parameters are arranged in a predetermined order in the report.

14. The computer-readable medium of claim 11, wherein the report is marked in different colors to indicate the value ranges of the values of the measured characteristic.

15. The computer-readable medium of claim 11, wherein the output device is a display screen or a printer.
